(19) United States
(12) Patent Application Publication
(10) Pub. No.: US 2007/0249412 A1
(43) Pub. Date: Oct. 25, 2007

(54) Handset holder for a vehicle

(75) Inventors: Kang-Wei Fan, Taipei (TW); Che-Ying Su, Taipei (TW)

Correspondence Address: BIRCH STEWART KOLASCH & BIRCH, PO BOX 747, FALLS CHURCH, VA, 22040-0747, US

(73) Assignee: ASUSTeK COMPUTER INC.

(21) Appl. No.: 11/730,875

(22) Filed: Apr. 4, 2007

(30) Foreign Application Priority Data
Apr. 21, 2006 (TW) 95114414

(51) Int. Cl. H04M 1/00

(52) U.S. Cl. 455/569.2

(57) ABSTRACT

A handset holder for a vehicle is used to hold a handset and an antenna. The fixed stand comprises a base body, a pipework, and an attaching device. The base body has a surface for receiving the handset. The pipework is a hollow structure and one end thereof is connected to the base body and another end is connected to the attaching device. A linking wire of the antenna is accommodated in the pipework. The attaching device has a containing trough for accommodating the antenna.

### FIELD OF THE INVENTION

The present invention relates to a handset holder for a vehicle, and more particularly to a handset holder having which is easy to assemble in the vehicle concisely.

### BACKGROUND OF THE INVENTION

Vehicles are indispensable for our normal life. Therefore, more handset products and accessories thereof used in vehicles are developed continuously.

For installing handset products in vehicles, handset holder for a vehicle have recently become quite popular.

For increasing signal-receiving effect, an adding antenna is required. Thus, the handset holder and the antenna will occupy the internal room of the vehicle and affect the decorations inside the vehicle.

Generally speaking, the handset is installed in a holder on a windshield normally for a driver watching the immediate road information and driving simultaneously. One end of the handset holder may be a sucker for adhering on the windshield; another end is used for fixing the handset. Please refer to FIG. 1, which illustrates a schematic view of a handset holder for a vehicle in prior arts. The handset holder includes a base body 10, a bracket 11, and an attaching seat 12. The base body 10 has a base member 101 and a jig 102. There is a containing trough is between the base member 101 and a jig 102 for accommodating the handset 103. The jig 102 can be two corresponding hooks. The jig 102 is disposed on both sides of the base member 101 for grasping the handset 103.

One end of the bracket 11 is connected to the base member 101, and another end is connected to the fixing seat 12. There is a sucker 121 in the back of the fixing seat 12 to adhere on the windshield or other places randomly.

Besides, the consumer usually adds an antenna 14 in the handset 103 to enhance the signal-receiving effect of the handset 103. For avoiding the antenna 14 shielding by a metal housing of the vehicle, the antenna 14 is usually attached to the exterior housing of the vehicle or the windshield. One end of the linking wire 141 of the antenna 14 is connected to the handset 103.

The handset holder and the antenna are additional elements. The arrangement of additional elements and surplus linking wires of the antenna may affect the decorations inside the vehicle.

In view of the above, an embodiment of the present invention provides a handset holder for holding objects and retaining a antenna which is easy to assemble and arrange in the vehicle.

### SUMMARY OF THE INVENTION

The primary objective of the present invention is to provide a handset holder with integrated antenna.

Accordingly, one embodiment of the present invention provides a handset holder which is used to retaining a handset, a linking wire, and an antenna in the vehicle. The linking wire electrically connects the handset and the antenna. The handset holder comprises a base body, an attaching device, and a pipework. The base body has a surface for the handset. The pipework is a hollow structure, and one end of the pipework is connected to the back of the base body, and the linking wire is accommodated in the pipework. The attaching device is used to attach at an appropriate place and connected to another end of the pipework. The antenna is disposed on the attaching device.

Further, the base body may include a base member for holding the handset, which has a hole for the antenna going through, and the antenna is connected to the handset. The base body, the pipework, and the attaching device may be integrated as a whole structure. The pipework may be made of flexible materials. The bottom of the attaching device may have a sucker, which is fixed on a windshield for supporting the handset holder.

For another embodiment, the handset holder with an antenna for a vehicle comprises a base body, a pipework, a linking wire, an attaching device, and an antenna. The base body has a surface for receiving the handset. The pipework is a hollow structure, and one end of the pipework is connected to the base body. The linking wire is electrically connected to the handset and accommodated in the pipework. The attaching device is used to attach to an appropriate place for receiving signals and connected to another end of the pipework. The antenna is disposed to the attaching device.

### BRIEF DESCRIPTION OF THE DRAWINGS

Other features and advantages of this invention will become more apparent in the following detailed description of the preferred embodiments of this invention, with reference to the accompanying drawings of:

FIG. 1 illustrating a schematic view of a handset holder for a vehicle in prior arts;

FIG. 2 illustrating a schematic view of a first preferred embodiment of the present invention;

FIG. 3 illustrating a schematic view of a second preferred of the present invention.

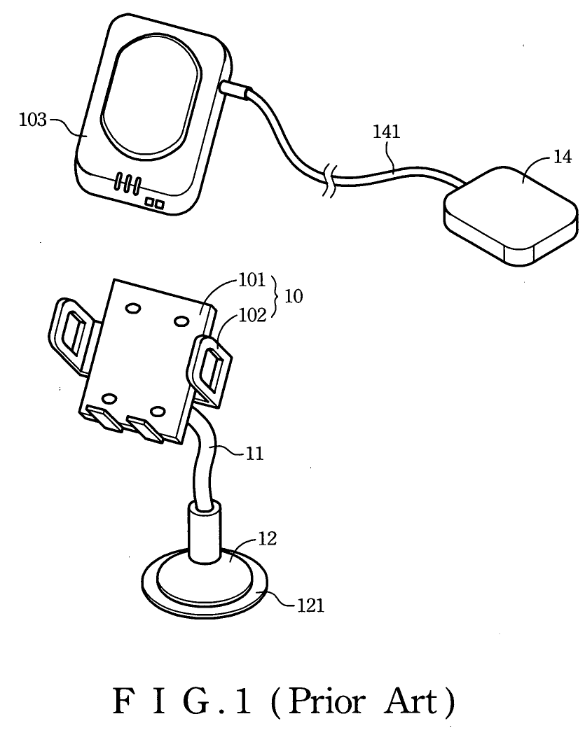

### DETAILED DESCRIPTIONS OF THE PREFERRED EMBODIMENT

The detailed descriptions in the present invention are as below:

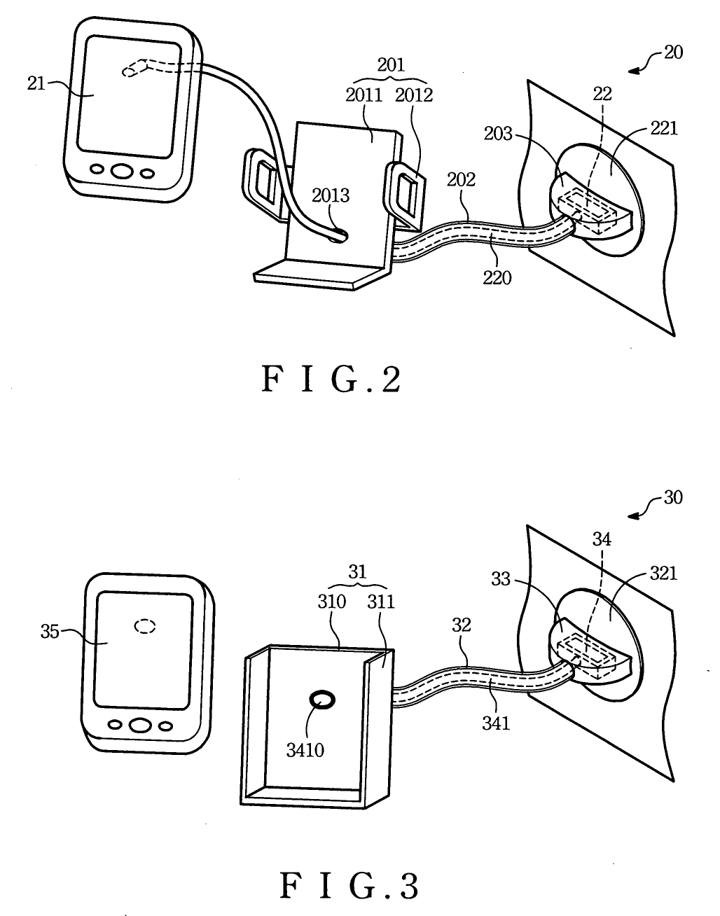

Please refer to FIG. 2, which illustrates a schematic view of a first preferred embodiment of the present invention. The handset holder 20 for a vehicle is used to hold a handset 21 and an antenna 22. The handset holder 20 comprises a base body 201, a pipework 202, and an attaching device 203. The base body 201 has a base member 2011 and a jig 2012. The base member 2011 has a surface for receiving the handset 21. The handset 21 is accommodated in a room between the base member 2011 and the jig 2012.

In this embodiment, the pipework 202 is a hollow structure, and one end of the pipework 202 is connected to the back of the base member 2011. While the linking wire 220 of the antenna 22 is accommodated in the pipework 202, the linking wire 220 is hid and protected.

In the embodiment, the attaching device 203 has a containing trough for accommodating the antenna 22, and the attaching device 203 is connected to another end of the pipework 202. Therefore, the present invention is used the attaching device 203 as a fulcrum to adhere on a windshield to receive signals. The antenna 22 is integrated in the attaching device 203, and the revealed linking wire 220 is hid in the pipework 202.

Accidentally, the base member 2011 of the base body 201 has a hole 2013 for the linking wire 220 of the antenna 22 going through, and the antenna 22 is connected to the handset 21. Further, the pipework 202 and the attaching device 203 are integrated as a whole structure. The base body 201 and the pipework 202 may be integrated as a whole structure as well or a demountable combination. The pipework 202 may be made of flexible materials. Besides, a bottom of the attaching device 203 has a sucker 221 for adhering on the windshield as the fulcrum of the handset holder.

The linking wire 220 is connected to a connector which electrical connected to the linking wire, while the handset 21 is in the base body 201, the handset 21 is electrically connected to the connector. It is to be noted, the linking wire 220 is through the hole 2013 to connect to the handset 21, the user can drag out the linking wire 220 from the pipework 202, then place in the connector and connect to the handset 21.

Please refer to FIG. 3, which illustrates a schematic view of a second preferred of the handset holder of the present invention. In the embodiment, a handset holder 30 for a vehicle includes a base body 31, a pipework 32, an attaching device 33, and an antenna 34. The base body 31 has a base member 310 and a jig 311. The base member 310 has a surface for receiving the handset 35. The handset 35 is accommodated in a room between the base member 310 and the jig 311. The pipework 32 is a hollow structure, and one end of the pipework 32 is connected to the back of the base member 310, and another end of the pipework 32 is connected to the attaching device 33. The attaching device 33 has a containing trough for accommodating the antenna 34, and the linking wire 341 of the antenna 34 is accommodated in the pipework 32. The bottom of the attaching device 33 has a sucker 321 for adhering on the windshield of the vehicle.

The base body 31 of the handset holder 30 further includes a connector 3410, which is electrically connected to an end of the linking wire 341, and the linked connector 3410 can be fixed on the base member 310. When the handset 35 is placed in the base body 31, the connector 3410 is thus electrically connected to the handset 35 by means of the antenna 34, the linking wire 341, and connector 3410.

However, the base body 31, the pipework 32, and the attaching device 35 may be integrated as a whole structure. For the convenience of adjusting the directions of antenna, the pipework 32 may be a demountable combination and made of flexible materials. Further, a bottom of the base member 310 has a charge contact so as to use and charge the handset simultaneously.

In the embodiment of the present invention, the handset can be any device receiving signals via the antenna. It is not limited to a handset, a digital TV, or a mobile phone.

Accordingly, the handset holder of the present invention has the merit of adjusting signal-receiving positions via the handset holder to obtain the best viewing effect and reach the optimize occupying room, the nice appearance, and the most convenience.

With the example and explanations above, the features and spirits of the invention are hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A handset holder for a vehicle used to retain a handset, a linking wire, and an antenna, the linking wire electrically connecting to the handset and the antenna, comprising:
a base body having a surface for receiving the handset;
an attaching device for attaching to an appropriate place, the antenna being disposed in the attaching device; and
a pipework being connected to the base body and the attaching device for accommodating the linking wire.

2. The handset holder for the vehicle according to claim 1, wherein the base body has a connector electrically connected to the linking wire, while the handset is disposed in the base body, the handset is electrically connected to the connector.

3. The handset holder for the vehicle according to claim 1, wherein the base body has a base member and a jig.

4. The handset holder for the vehicle according to claim 3, wherein the base member has a hole for the antenna going through, and the antenna is connected to the handset.

5. The handset holder for the vehicle according to claim 1, wherein the base body, the pipework, and the attaching device are integrated as a whole structure.

6. The a handset holder for the vehicle according to claim 1, wherein the pipework is made of flexible materials.

7. The handset holder for the vehicle according to claim 1, wherein the attaching device has a sucker, and the attaching device is used to attach to the appropriate place by means of the sucker.

8. The handset holder for the vehicle according to claim 1, wherein the attaching device has a containing trough for accommodating the antenna.

9. The a handset holder for a vehicle according to claim 1, wherein the handset is a digital TV.

10. A handset holder with an antenna for a vehicle used to a handset, comprising:
a base body having a surface for receiving the handset
an attaching device for attaching to an appropriate place, the antenna being disposed in the attaching device;
a pipework being connected to the base body and the attaching device; and
a linking wire electrically connecting to the handset and the antenna and being accommodated in the pipework.

11. The handset holder for the vehicle according to claim 10, wherein said base body has a connector electrically connected to the linking wire, while the handset is disposed in the base body, the handset is electrically connected to the connector.

12. The a handset holder for a vehicle according to claim 10, wherein the base body has a base member and a jig.

13. The a handset holder for a vehicle according to claim 12, wherein the base member has a hole for the antenna going through, and the antenna is connected to the handset.

14. The handset holder for a vehicle according to claim 10, wherein the linking wire comprises a connector, which is connected in the handset for electrical connection.

15. The handset holder for the vehicle according to claim 10, wherein the pipework and the attaching device are integrated as a whole structure.

16. The handset holder for the vehicle according to claim 10, wherein the base body and the pipework are integrated as a whole structure.

17. The handset holder for the vehicle according to claim 10, wherein the base body and the pipework are demountable.

18. The handset holder for the vehicle according to claim 10, wherein the pipework is made of flexible materials.

19. The handset holder for the vehicle according to claim 10, wherein the attaching device has a sucker, and the attaching device is used to attached to the appropriate place by means of the sucker.

20. The handset holder for the vehicle according to claim 10, wherein said handset is a digital TV.
